(19) United States
(12) Patent Application Publication
(10) Pub. No.: US 2010/0183241 A1
(43) Pub. Date: Jul. 22, 2010

(54) RESTORATION METHOD FOR BLURRED IMAGES USING BI-LEVEL REGIONS

(75) Inventors: Yu-Mo Lin, Taichung City (TW); Po-Hao Huang, Kaohsiung County (TW); Shang-Hong Lai, Hsinchu City (TW); Chih-Chih Huang, Hsinchu County (TW); Shu-Han Yu, Taoyuan County (TW); Yu-Chun Peng, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/619,766

(22) Filed: Nov. 17, 2009

(30) Foreign Application Priority Data
Jan. 21, 2009 (TW) 098102331

(51) Int. Cl. G06K 9/38

(52) U.S. Cl. 382/270; 382/274

(57) ABSTRACT

A blind image restoration method restores a motion blurred image and a blur kernel is estimated based on an intrinsic bi-level image region of the motion blurred image. In addition, the blur kernel is iteratively estimated. When the blur kernel is iteratively estimated, bi-level image priors are introduced to achieve better image restoration.

This application claims the benefit of Taiwan application Serial No. 98102331, filed Jan. 21, 2009, the subject matter of which is incorporated herein by reference.

### BACKGROUND OF THE INVENTION

1. Field of the Invention

The invention relates in general to a restoration method for restoring a motion blurred image, and more particularly to a method of restoring a motion blurred image using bi-level regions.

2. Description of the Related Art

In the modern age, in which the technology is changing with each passing day, photographing an image (e.g., motion image) using a digital camera, a digital still camera or a mobile phone with a photographing function has become a general behavior in the daily life of the modern human beings.

In photographing, the user may fix the digital still camera to a foot stand to stabilize the digital still camera and prevent the digital still camera from shaking, in order to obtain the better image quality. A foldable foot stand is available so that the inconvenience of carrying the foot stand can be reduced, but the user may feel inconvenient in carrying the foot stand. However, the blurred image may be obtained in photographing due to shake of user's hand if the digital still camera is not fixed to the foot stand. Thus, a restoration method for restoring blurred images is needed to restore the blurred image for getting high quality image.

### SUMMARY OF THE INVENTION

An example of the application is directed to an image restoration method for restoring a blurred image; and a motion blur kernel is estimated based on an intrinsic bi-level image region of the blurred image. During the blind image restoration, blur kernel is estimated and image is restored.

Another example of the application is directed to an image restoration method for iteratively obtaining a blur kernel in estimate of the blur kernel. A kernel prior is introduced in estimate of the blur kernel, to stabilize the solution.

Still another example of the application is directed to an image restoration method for restoring an image according to image priors, which is advantageous to the achieving of the better restoration result and can reduce the ringing artifact.

According to examples of the present invention, an image restoration method applied to an image acquisition device is provided. The method includes: receiving a blurred image; selecting at least one first image region of the blurred image; performing thresholding and brightness compensation on the first image region to obtain a second image region; estimating a blur kernel of the blurred image based on the first image region, the second image region and a first image prior; restoring the second image region based on the blur kernel, a second image prior and a third image prior; and restoring the blurred image based on the blur kernel and the third image priors and outputting the restored blurred image if the restored second image region is converged.

The invention will become apparent from the following detailed description of the preferred but non-limiting embodiments. The following description is made with reference to the accompanying drawings.

### BRIEF DESCRIPTION OF THE DRAWINGS

FIG. 1 is a flow chart showing a blurred image restoration method according to an embodiment of the invention.

FIG. 2A shows an image region in a blurred image.

FIG. 2B shows a result obtained after thresholding of the image region of FIG. 2A.

FIG. 2C shows a blur kernel, which is estimated based on FIGS. 2A and 2B.

FIG. 2D shows a restored region based on the estimated blur kernel.

### DETAILED DESCRIPTION OF EXAMPLES OF THE INVENTION

In an embodiment of the invention, a motion blurred image is restored, wherein a blur kernel may be estimated based on an intrinsic bi-level image region of the blurred image to perform restoration. In the blind image restoration, the blur kernel is estimated and the image is restored. In estimate of the blur kernel, the blur kernel is iteratively obtained. The image region is restored according to image priors, which are advantageous to the achieving of the better restoration result so that the ringing artifact can be reduced. In addition, the kernel prior is introduced in estimate of the blur kernel, to stabilize the solution. In here, the so-called blind image restoration represents that the blur kernel is unknown when the blurred image is inputted. That is, the blur kernel is estimated from the inputted blurred image.

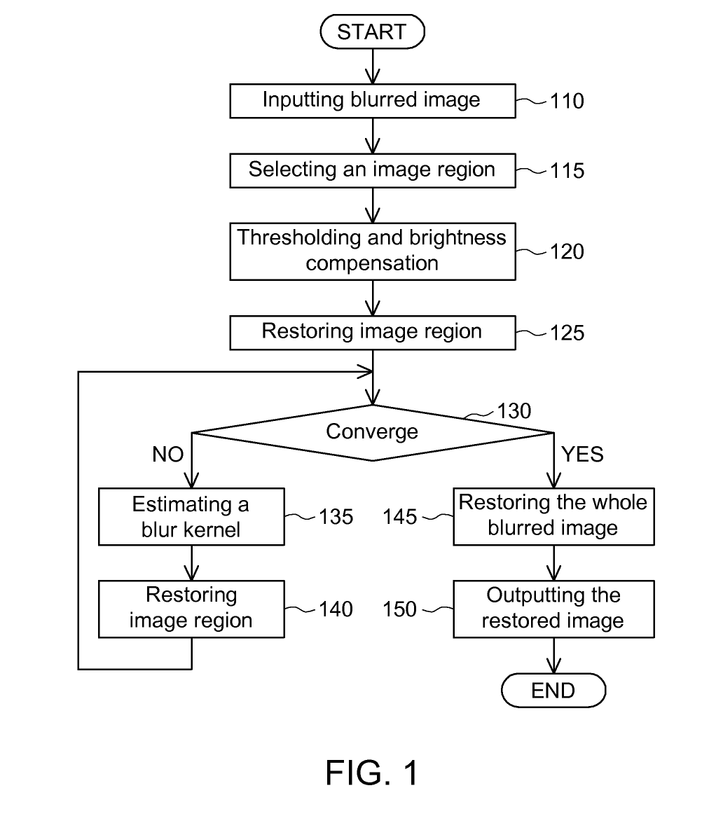

FIG. 1 is a flow chart showing a blurred image restoration method according to an embodiment of the invention. As shown in FIG. 1, a blurred image is inputted, as shown in step 110. The blurred image is captured by, for example, an image acquisition device (a digital camera, a digital still camera, a mobile phone with the photographing function, or the like).

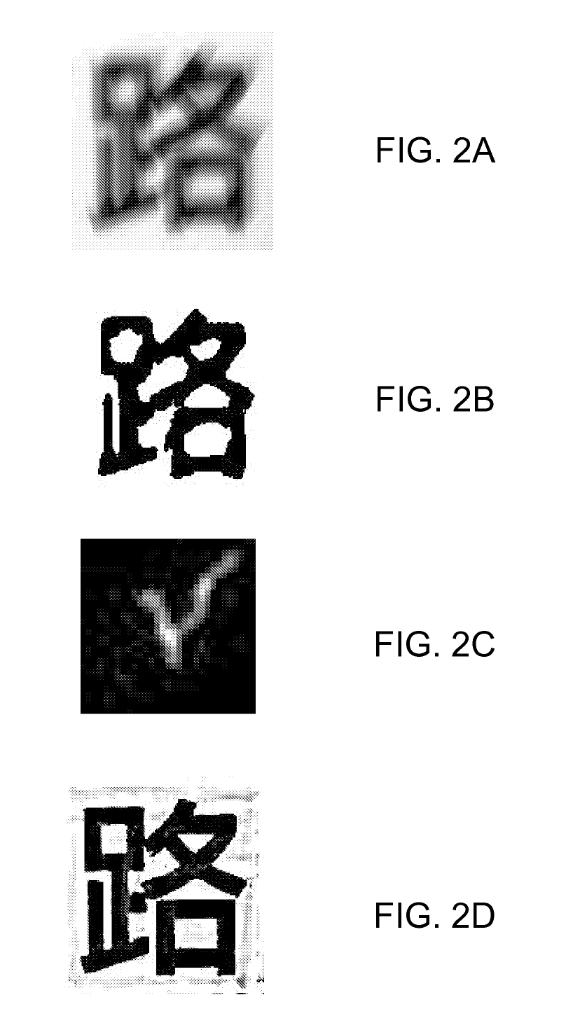

Then, in step 115, at least one blur bi-level image region is selected form the blurred image. The blur bi-level image region is a blurred image region which only contains two colors and their mixtures. Herein, the blurred image region is a rectangular image region, for example. The blurred image region is transferred to gray level. FIG. 2A shows an image region of a blurred image. Then, in step 120, thresholding and brightness compensation are performed on the blurred image regions. Herein, the so-called thresholding means that intensity values of all pixels in the blurred region are reset based on a threshold value. Taking 8-bit gray level as an example, wherein the intensity values range from 0 to 255. It is assumed that the threshold value is 127. In thresholding, the intensity values of the pixels in the blurred region lower than 127 are reset to 0 (black), and the intensity values of the pixels in the blurred region higher than 127 are reset to 255 (white). So, the blurred region after thresholding only contains two colors (white and black). FIG. 2B shows the result after thresholding is performed on the image region of FIG. 2A.

Next, in step 125, the image region is restored. Before a blur kernel is estimated, the result obtained in the step 120 is the result obtained in the step 125, that is, the image region obtained after thresholding is regarded as the image obtained after the first restoration.

Next, in step 130, it is judged whether the restored image region converges. If not, the procedure goes to step 135. On the contrary, if yes, the procedure goes to step 145.

In the step 135, the blur kernel is estimated based on the blurred region (selected in the step 115), and the image region (obtained after the restoration in the step 125). In the embodiment, the estimated blur kernel is a two-dimensional gray-level image (or a rectangular image), which represents the track of camera shaking. FIG. 2C shows a blur kernel estimated based on FIGS. 2A and 2B.

Thereafter, in step 140, the image region is restored based on the estimated blur kernel. FIG. 2D shows a restored image region based on the estimated blur kernel.

Then, the procedure goes back to the step 130 to judge whether the restored image region converges.

If the restored image region converges, which means that the estimated blur kernel is unchanged, in the step 145, the overall blurred image is restored based on the estimated blur kernel. Next, in step 150, the restored image is outputted. Taking a digital still camera as an example, the restored image is what viewed by user on a display of the digital still camera, and the original blurred image will not be viewed by the user.

In addition, in the embodiment of the invention, the blur kernel is iteratively estimated until the restored region converges, which is only one of many possible implementations. Other methods may also be adopted. For example, the blur kernel is iteratively estimated until the estimated blur kernel converges; or the iteration times are restricted.

Now, how to estimate the blur kernel and restore the region (and the overall image) in the embodiment will be described in the following.

In the embodiment, the blur kernel estimation and the bi-level image restoration are merged in the MAP (Maximum A Posteriori) formula using a possibility model. The so-called bi-level image represents the image region after thresholding. As shown in FIG. 1, the image region restoration step is iteratively performed between the blur kernel estimation and the subsequent image estimation (to estimate whether the restored image region converges). Thus, a better blur kernel and a better image restoration effect may be obtained.

In the embodiment, the image restoration is based on the Bayesian possibility model. Based on the Bayesian possibility model and the assumption that the restored image F is independent from the blur kernel H, the posteriori P(F,H|G) may be written as follows:

P(F,H|G)∝P(G|F,H)P(F)P(H) (1),

wherein P(G|F, H) represents the likelihood, P(F) represents the prior of the restored image F and P(H) represents the prior of the blur kernel H. Herein, it is to find the restored image F and the blur kernel H, which make a maximum posteriori P(G|F, H). G represents the blurred image. In this embodiment, the restored image F is what obtained after the restoration step 125 of FIG. 1.

If the restored image F and the blur kernel H are given, then the likelihood of the blurred image G may be determined according to the image noise N=G−F [symbol] H. More particularly, it is assumed that the image noise N is in independent and identically distribution (i.i.d.), and the distribution of the gray levels of the pixels may be emulated as the Gaussian distribution. Under this assumption, the likelihood P(G|F, H) may be represented as:

$$P ( G \vert F , H ) ∝ exp ( - \frac{1}{2 {η}^{2}} {‖ G - F ⊗ H ‖}_{2}^{2} ) , \qquad ( 2 )$$

wherein η represents the standard deviation of the Gaussian distribution, ∥∥ represents the 2-norm operator, ∥G−F [symbol] H∥ is a fidelity constraint which represents the difference between the blurred image and the convolution F [symbol] H. The convolution F [symbol] H is the convolution of the (restored) image F with the estimated blur kernel H. That is, the blurred image may be represented by the convolution of the (restored) image F with the estimated blur kernel H.

The blind image restoration is an ill-posed problem. In order to overcome the illness, the image prior is introduced into the image restoration in this embodiment. In the model of this embodiment, the image prior P(F) of the restored image F includes two components. That is, P(F) may be represented as follows:

P(F)∝P_{b}(F)Pₛ(F) (3),

wherein P_{b}(F) represents a bi-level prior and P_{S}(F) represents a sparse prior. Details of the two image priors will be described in the following.

In the embodiment, after the image F is normalized, P_{b}(F) may be represented as:

$${P}_{b} ( F ) ∝ exp ( - {λ}_{1} {\sum }_{i ∈ {Ω}_{F}} \vert 1 - {F}_{i}^{2} \vert ) , \qquad ( 4 )$$

wherein λ₁ represents a rate parameter, Fᵢ represents a image intensity of pixels of the image F after the image F is normalized. In normalization, the image intensity of pixels of the image F is linearly transformed to a zone ranging from −1 to 1 (black color corresponds to −1, and white color corresponds to 1). Ω_{F} represents a set of all pixels in the image F. It is to be noted that the parameter |1−Fᵢ²| preferably approaches 0. That is, after the restored image F is normalized, the image intensity of each pixel is preferably equal to 1 or −1. That is, it is preferred that the restored image only includes two colors (white and black).

In the embodiment, based on observation, the differentiation of the bi-level image also follows the heavy-tailed distribution. This represents that the image gradient is almost equal to zero or a very small value. Thus, the sparse prior Pₛ(F) may be modeled, according to the heavy-tailed function, as follows:

$${P}_{s} ( F ) ∝ exp ( - {λ}_{2} {\sum }_{i ∈ {Ω}_{F}} [ Φ ( \frac{\partial {F}_{i}}{\partial x} ) + Φ ( \frac{\partial {F}_{i}}{\partial y} ) ] ) , \qquad ( 5 )$$

wherein λ₂ represents a rate parameter, x and y respectively represent horizontal differentiation and vertical differentiation, and function Φ represents the heavy-tailed function. Herein, it is assumed that Φ(x)=|x|^{0.8}.

To stabilize the solution, the kernel prior P(H) is defined as follows:

$$P ( H ) ∝ exp ( - {λ}_{3} {\sum }_{i ∈ {Ω}_{H}} {H}_{i}^{2} ) , \qquad ( 6 )$$

wherein λ₃ represents a rate parameter, Ω_{H} represents the set of all pixels in the blurred kernel.

Synthesizing the above-mentioned formulas, the posteriori has to be maximized to obtain high quality restored image during the image restoration:

$$P ( F , H \vert G ) ∝ exp ( - \frac{1}{2 {η}^{2}} {‖ G - F ⊗ H ‖}_{2}^{2} - {λ}_{1} {\sum }_{i ∈ {Ω}_{F}} \vert 1 - {F}_{i}^{2} \vert ) \\ exp ( - {λ}_{2} {\sum }_{i ∈ {Ω}_{F}} [ Φ ( \frac{\partial {F}_{i}}{\partial x} ) + Φ ( \frac{\partial {F}_{i}}{\partial y} ) ] - {λ}_{3} {\sum }_{i ∈ {Ω}_{H}} {H}_{i}^{2} ) . \qquad ( 7 )$$

If the MAP formula is given, in order to solve the formula (7), a logarithm value of the right portion on the formula (7) is obtained and then a negative value of the logarithm value is obtained, which may be represented as:

$$E ( F , H ) = {‖ G - F ⊗ H ‖}_{2}^{2} + {α}_{1} {\sum }_{i ∈ {Ω}_{F}} \vert 1 - {F}_{i}^{2} \vert + {α}_{2} {\sum }_{i ∈ {Ω}_{F}} [ Φ ( \frac{\partial {F}_{i}}{\partial x} ) + Φ ( \frac{\partial {F}_{i}}{\partial y} ) ] + {α}_{3} {\sum }_{i ∈ {Ω}_{H}} {H}_{i}^{2} , \qquad ( 8 )$$

wherein α₁=2η²λ₁, α₂=2η²λ₂, and α₃=2η²λ₃.

Thus, the solution for the maximized posteriori formula (7) is transformed into a solution for a minimum of E(F,H) in the formula (8). That is, if the minimum of E(F,H) can be obtained, which means the solution for the maximized posteriori formula (7) is obtained, then a high quality image restoration result is obtained. The minimum of E(F,H) may be obtained as follows. An optimum ideal image F is obtained assuming the blur kernel H is given. In addition, an optimum blur kernel H is obtained assuming the ideal image F is given. The methods will be described in the following.

Obtain the Optimum Ideal Image F when the Blur Kernel H is Given

Assuming that the currently estimated blur kernel H is fixed (i.e., the kernel H is regarded as known), the formula (8) is minimized to obtain the optimum ideal image F.

Assuming that the image noise N is neglected (i.e., the image noise is set as 0), N=G−F [symbol] H may be rewritten, and the convolution is regarded as a matrix multiplication:

G=F [symbol] H [symbol] g=Cₕf (9),

wherein Cₕ is an L×L two-dimensional matrix and is determined by the estimated blur kernel, and f and g are one-dimensional vectors which represent the image F and the blurred image G. Herein, L is a product of the height and the width of the blurred image. After the constant item (known item) is removed, E(F,H) may be simplified as E_{F}(f) and represented as follows:

$${E}_{F} ( f ) = {‖ g - {C}_{h} f ‖}_{2}^{2} + {α}_{1} {\sum }_{i} \vert 1 - {f}_{i}^{2} \vert + {α}_{2} \sum [ Φ ( {C}_{gh} f ) + Φ ( {C}_{gv} f ) ] , \qquad ( 10 )$$

wherein C_{gh} and C_{gv} represent matrixes determined according to the horizontal derivative filter [1, −1] and the vertical derivative filter [1, −1].

In order to minimize E_{F}(f) of the formula (10), we derivate the formula (10) with respect to f by setting Φ(x)=|x|². Consequently, the derivative of the formula (10) with respect to f is taken and set to be equal to 0 so as to obtain a set of linear equations as follows:

$$\begin{matrix}\frac{\partial {E}_{F}}{\partial f} = 0 ⇒ [ {C}_{h}^{T} {C}_{h} - {α}_{1} {W}_{b} + {α}_{2} ( {C}_{gh}^{T} {W}_{kh}^{0} {C}_{gh} + {C}_{gv}^{T} {W}_{kv}^{0} {C}_{gv} ) ] f \\ = {C}_{h}^{T} g ,\end{matrix} \qquad ( 11 )$$

wherein Wₖₕ⁰ and Wₖᵥ⁰ are both a diagonal weighting coefficient matrix, whose initialization is an identity matrix, and W_{b} is a diagonal binary mask and may be represented as follows:

W_{b}(i,i)=1 when −1<fᵢ<1 (12A)

W_{b}(i,i)=−1 otherwise (12B)

The formula (II) is calculated using the conjugate gradient method. Next, an iterative re-weighted least squares process (IRLS) is adopted to optimize the formula (II). The re-weighting term may be represented as follows:

Wₖₕ^{t}=diag(max(C_{gh}f,ε)^{0.8-2}) (13A)

Wₖᵥ^{t}=diag(max(C_{gv}f,ε)^{0.8-2}) (13B)

wherein t represents the t^{th} iteration in IRLS, and the parameter ε prevents the division by zero. Parameters α₁ and α₂ are reduced over iteration.
Obtain the Optimum Blur Kernel H when the Ideal Image F is Given

Next, how the optimum blur kernel H is determined with respect to the given ideal image F in this embodiment will be described. Similarly, the image noise N is neglected, G=F [symbol] H [symbol] g=Ah is written, and the convolution is regarded as a matrix multiplication:

G=F [symbol] H [symbol] g=Ah (14),

wherein the matrix A is composed of the image F, h represents an one-dimensional vector of K², K represents a dimension (length or width thereof) of the blur kernel, and g represents an one-dimensional vector of the blurred image G. For the given image F, E(F,H) may be simplified as E_{H}(h) represented as follows:

E_{H}(h)=∥g−Ah∥₂²+α₃∥h∥₂² (15),

In order to minimize E_{H}(f) of the formula (15), the derivative of the formula (15) with respect to h is taken and set to be equal 0 so as to obtain a set of linear equations as follows:

$$\frac{\partial {E}_{H}}{\partial h} = 0 ⇒ [ {A}^{T} A + {α}_{3} I ] h = {A}^{T} g \qquad ( 16 )$$

wherein I is an identity matrix.

In summary, the embodiment of the invention iteratively estimates the blur kernel based on the blurred image to obtain the optimum blur kernel. Then, the estimated blur kernel is utilized to restore the blurred image. In estimate of the blur kernel, image priors may be introduced. These image priors are advantageous to the achieving of a better restoration result, and can reduce the ringing artifact.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image restoration method applied to an image acquisition device, the method comprising:
receiving a blurred image;
selecting at least one first image region of the blurred image;
performing thresholding and brightness compensation on the first image region to obtain a second image region;
estimating a blur kernel of the blurred image based on the first image region, the second image region and a first image prior;
restoring the second image region based on the blur kernel, a second image prior and a third image prior; and
restoring the blurred image based on the blur kernel and the third image prior and outputting the restored blurred image if the restored second image region is converged.

2. The method according to claim 1, wherein the thresholding step comprises:
resetting intensity values of all pixels in the first image region based on a first threshold value, wherein:
the intensity values of the pixels lower than the first threshold value are reset as a first value; and
the intensity values of the pixels higher than the first threshold value are reset as a second value.

3. The method according to claim 1, wherein the blur kernel is a two-dimensional gray-level image and represents a camera shake track.

4. The method according to claim 1, further comprising:
setting the blur kernel and the restored second image region are independent from each other.

5. The method according to claim 1, wherein the first image prior comprises a kernel prior, the second image prior comprises a bi-level prior, and the third image prior comprises a sparse prior.

6. The method according to claim 1, wherein the step of restoring the second image region comprises:
determining a likelihood of the blurred image according to an image noise if the blur kernel and the restored second image region are known.

7. The method according to claim 1, wherein the blurred image is represented by a convolution of the restored second image region with the blur kernel.

8. The method according to claim 1, further comprising:
normalizing the restored second image region to determine the second image prior.

9. The method according to claim 1, further comprising:
obtaining an optimum restored second image region if the blur kernel is assumed to be known; and
obtaining an optimum blur kernel if the restored second image region is assumed to be known.

10. The method according to claim 1, further comprising:
if the restored second image region is not converged yet, iteratively estimating the blur kernel until the restored second image region is converged.
